(19) United States
(12) Patent Application Publication
(10) Pub. No.: US 2006/0061089 A1
(43) Pub. Date: Mar. 23, 2006

(54) Lenticular covered promotional system and method

(76) Inventor: James Arlook, Park City, UT (US)

Correspondence Address: RADER, FISHMAN & GARAUER PLLC, 10653 SOUTH RIVER FRONT PARKWAY, SUITE 150, SOUTH JORDAN, UT, 84095, US

(21) Appl. No.: 11/230,361

(22) Filed: Sep. 19, 2005

Related U.S. Application Data
(60) Provisional application No. 60/612,588, filed on Sep. 23, 2004.

(51) Int. Cl. B42D 15/00

(52) U.S. Cl. 283/56

(57) ABSTRACT

A promotional system includes a logo receiving medium, and a message reception component removably coupled to the logo receiving medium, wherein the message reception component includes a message reception medium having a limited life, a backing, and a cover, the message reception component being coupled between the backing and the cover.

### RELATED APPLICATIONS

The present application claims the benefit of Provisional Application Ser. No. 60/612,588, filed Sep. 23, 2004, which application is incorporated herein by reference in its entirety.

### FIELD

The present system and method relate to advertising and promotional merchandise. More particularly, the present system and method provide a marketing system including a convenient message receptive medium and an informational component.

### BACKGROUND

With the ever increasing quantity of products and services being offered to consumers, substantial interest has been given to promotional systems designed to enhance the advertising of such products and services. In this regard, a wide variety of advertising displays and promotional literature has been created and distributed to consumers. However, due to the deluge of material to which average consumers are constantly exposed, greater emphasis has been placed upon developing promotional systems that are not only eye-catching to capture the consumer attention, but also provide a utility to the consumer.

In advertising venues such as trade shows, expos, and conventions where consumers are approached by multiple vendors offering products and services, the traditional use of business cards and fliers proves to be less-effective. Traditional business cards and fliers are limited in their utility apart from identifying a product or service offering source. Consequently, unless there is a high interest for the information on the card or flier, a potential consumer will often loose a vendor's card or simply place it away until a great need dictates its retrieval. This may prove detrimental to many vendors and suppliers whose business success often relies on maintaining their name and/or product information in front of potential and existing customers.

In an attempt to generate a unique advertising display that maintains a vendor or a supplier's name in front of potential consumers, some prior art products have employed complex folding systems which produce a three-dimensional display when activated or unfolded. However, in spite of the unique and/or artistic visual appearance generated by such products, the overall usefulness to a consumer or potential customer is minimal. Moreover, the cost of production and complexity of such systems has prevented such prior art systems from becoming popular.

Additional advertising methods have also been used in an attempt to maintain a vendor or a service provider's name in front of potential consumers by providing unique visual images or other indicia as an integral part of the display. However, as mentioned previously, these methods are less effective because they lack a secondary utility that may be initially valued by potential consumers.

### SUMMARY

A promotional system includes a logo receiving medium, and a message reception component removably coupled to the logo receiving medium, wherein the message reception component includes a message reception medium having a limited life, a backing, and a cover, the message reception component being coupled between the backing and the cover.

### BRIEF DESCRIPTION OF THE DRAWINGS

The accompanying drawings illustrate various embodiments of the present method and system and are a part of the specification. Together with the following description, the drawings demonstrate and explain the principles of the present system and method. The illustrated embodiments are examples of the present system and method and do not limit the scope thereof.

FIG. 1 is a simple perspective view illustrating an assembled promotional unit, according to one exemplary embodiment.

FIG. 2 is an exploded view of a promotional unit illustrating the individual components of the promotional unit, according to one exemplary embodiment.

FIG. 3 is a simple perspective view illustrating the components of the message receptive medium, according to one exemplary embodiment.

FIG. 4 is a simple perspective view illustrating the components of the message receptive medium, according to one exemplary embodiment.

FIG. 5 is a simple side view illustrating the components of an extended life promotional unit, according to one exemplary embodiment.

FIG. 6 is a magnified view illustrating the components of a lenticular device, according to one exemplary embodiment.

FIGS. 7A and 7B are perspective views illustrating an assembled promotional unit, according to one exemplary embodiment.

FIG. 8 is a perspective view illustrating a folding promotional housing, according to one exemplary embodiment.

FIG. 9 is a side view illustrating an assembled folding promotional unit, according to one exemplary embodiment.

Throughout the drawings, identical reference numbers designate similar but not necessarily identical elements.

### DETAILED DESCRIPTION

The present specification describes a system and a method for producing a single promotional unit configured to provide a utilitarian value to potential customers while simultaneously facilitating the retention and identification of a promotional source. More particularly, the present system and method is configured to provide a potential customer with a noticeable source identifier coupled to a useful message receptive medium. Accordingly, the present system and method efficiently advertise the identifying information of a source while providing a potential consumer with an incentive to retain the identifying information in a readily accessible location. A number of exemplary components and configurations of the present system will be illustrated in further detail below.

In the present specification and in the appended claims, the term “magnetic” is meant to be understood broadly as any material having an attraction to ferrite based materials.

Additionally, as used herein and in the appended claims, the term “removably coupled” shall be interpreted broadly as including any number of coupling means wherein a card or other promotional component may be positionally secured to a system until a tensional force is applied thereto, wherein the promotional material may be removed from the system.

In the following description, for purposes of explanation, numerous specific details are set forth in order to provide a thorough understanding of the present system and method for producing a single promotional unit that provides a utilitarian value to potential customers while simultaneously facilitating the retention and identification of a source. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

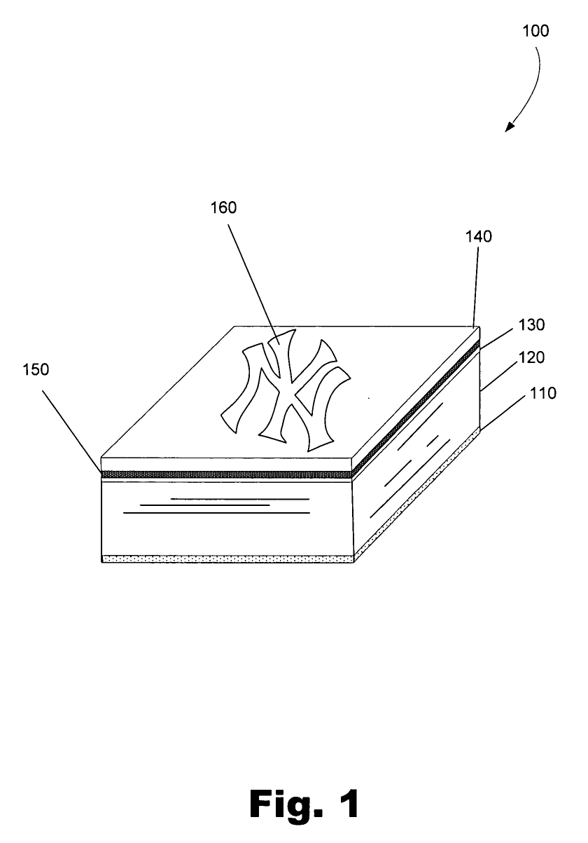

FIG. 1 illustrates an assembled promotional unit, according to one exemplary embodiment. As illustrated in FIG. 1, the promotional unit (100) may include a number of components coupled together to form a single functional unit. As shown, the promotional unit (100) includes a support backing (110) coupled to a message receptive medium (120). On top of the message receptive medium (120) is a pad cover (130) physically separating the message receptive medium (120) from a magnetic surface (150). Moreover, a logo receptive medium (140) having a logo/identifier (160) disposed thereon is fixedly coupled to the magnetic surface (150).

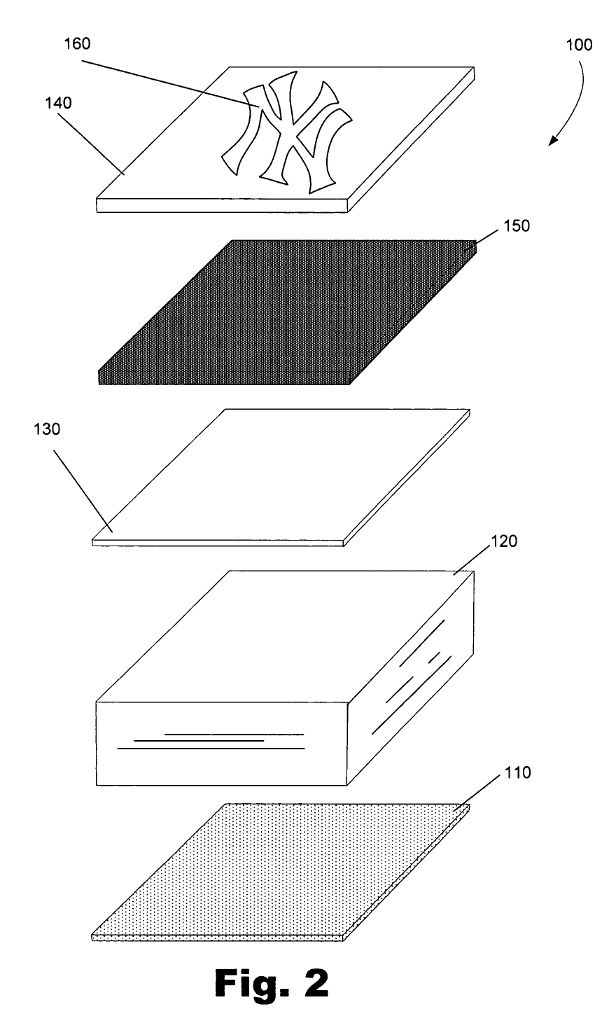

FIG. 2 is an exploded view further illustrating the assembly of the present promotional unit (100). As illustrated in the exemplary embodiment of FIG. 2, all of the individual components of the assembled promotional unit (100) may have approximately the same planar dimensions to demonstrate that when assembled, the independent components form a single functional unit. According to one exemplary embodiment, the assembled promotional unit (100) has footprint dimensions substantially similar to the dimensions of a traditional business card; or approximately two (2) inches by three and a half (3.5) inches. Alternatively, the dimensions may vary widely depending on the additional functions desired to be performed by the promotional units (100), the support backing (110), and the message receptive medium (120). Incorporation of the present system and method into a footprint that is approximately the dimensions of a traditional business card provides for convenience in storing and transporting the assembled promotional unit (100; FIG. 1). While the exemplary embodiment illustrated in FIG. 2 includes multiple components having similar planar dimensions, any number of variations may be made to the independent components of the promotional unit (100) to highlight or otherwise distinguish the components from one another. While the present promotional unit may be packaged and sold as a single functional unit, each independent component of the present promotional unit (100) will be described in further detail below.

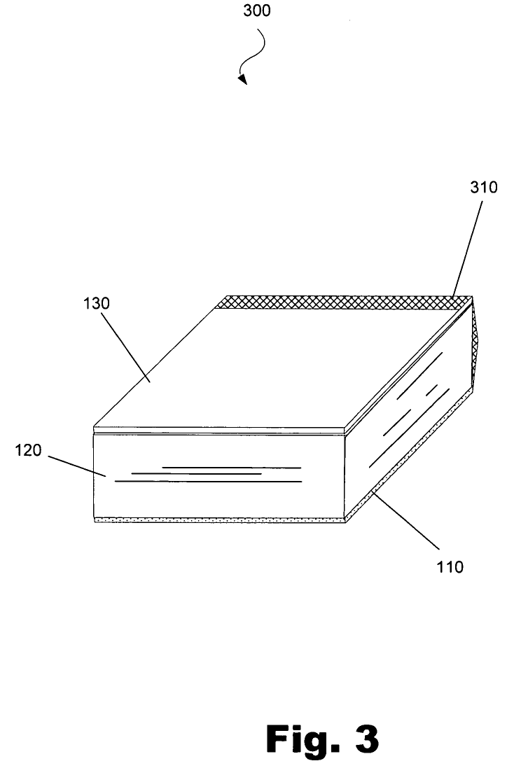

FIG. 3 illustrates an assembled message reception unit (300), according to one exemplary embodiment. As illustrated in FIG. 3, the exemplary message reception unit (300) includes a pad cover (130) and a backing (110) securely coupling the message receptive medium (120) there between. Moreover, a binder (310) is used to securely couple the individual components.

According to one exemplary embodiment, the binder (310) used to bind the message reception unit (300) may include any adhesive, configuration, or mechanical fastener configured to securely fasten the components of the message reception unit (300). According to one exemplary embodiment, the binder (310) may include, but is in no way limited to, an adhesive such as glue, epoxies, or tape; material configurations such as perforations extending through adjacent sheets of message receptive medium; or a mechanical fastener such as one or more staples, paper clips, brads, or binder clips. The binder (310) securely couples the pad cover (130) and the backing (110) to the message receptive medium (120). Moreover, the binder (310) may removably couple the message receptive medium (120), according to one exemplary embodiment, such as is employed by a post-it® brand note. According to one exemplary embodiment, the message receptive medium (120) may be organized into fan fold configuration where alternating sides of each sheet of message receptive medium (120) include a binder (310) such as a semi-permanent adhesive binding. According to this exemplary embodiment, subsequent sheets of message receptive medium (120) are securely, yet removably coupled in an offset fashion. Additionally, the adhesive configuration may include placing an adhesive tape on one or both sides of the backing (110) and/or pad cover (130) to reinforce the coupling to the message receptive medium (120).

The backing (110) portion of the message reception unit (300) is configured to support and protect the individual components of the promotional unit (100; FIG. 1), according to one exemplary embodiment. As illustrated in FIG. 3, the backing (110) may include any number of structural or protective materials including, but in no way limited to, chip board, vinyl, plastic, laminate, metal, composite, or appropriate combinations thereof. Additionally, organic based materials such as press board or other wood products may be used as the structurally supportive backing (110) component of the message reception unit (300). The backing (110) portion of the message reception unit (300) may be any mill weight or thickness sufficient to support and/or protect the message receptive medium (120) disposed therein. In addition to forming a structural support for the other components of the promotional unit (100; FIG. 1), the backing (110) portion of the message reception unit (300) may form a convenient coupling point for the message reception unit (300), as will be further developed below with reference to FIG. 9.

Further, the backing (110) portion of the message reception unit (300) may assume any form or perform any function attributed herein to the pad cover (130). Additionally, the backing may assume the form of a plastic or otherwise stiff material including a transparent pouch or opening configured to house a card or name tag. According to this exemplary embodiment, the backing (110) may be removed from the message reception unit (300) and used as a travel/luggage tag.

The pad cover (130) portion of the message reception unit (300) is disposed opposite the backing (110) portion with respect to the message receptive medium (120), as illustrated in FIG. 3. The pad cover (130) is configured to protect and couple the message receptive medium (120), according to one exemplary embodiment. Additionally, the pad cover (130) portion of the message reception unit (300) separates the message reception unit (300) from the other components of the promotional unit (100; FIG. 1). According to one exemplary embodiment, the pad cover (130) may be formed out of any number of materials including, but in no way limited to, plastic, paper, metal, composite, organic, or non-organic material. Further, the pad cover (130) may include, but is in no way limited to, a lenticular magnet, lenticular with no magnet, plain plastic, leather, hologram, cloth, or any other medium. Moreover, either and/or both sides of the pad cover (130) and/or the backing (110) may include any number of logos, identifiers, and/or utility markings such as calendars to further enhance the utilitarian function of the message reception unit (300).

The message reception medium (120) disposed between the pad cover (130) and the backing (110) provides the functional component of the present promotional unit (100; FIG. 1), having a limited life. As used herein and in the appended claims, the term “limited life” is meant to be understood broadly as an expendable message reception medium whose utility may be extinguished by repeated use. According to one exemplary embodiment, the message receptive medium (120) disposed between the pad cover (130) and the backing (110) includes a plurality of paper sheets configured to receive a message from any number of marking devices, such as pens, pencils, markers, crayons, and/or paint. According to this exemplary embodiment, the plurality of paper sheets disposed between the pad cover (130) and the backing (110) are configured to serve as a message pad or a note book for recording and/or tearing away notes or messages. The paper sheets of the present message reception unit (300) may have any number of variable characteristics. By way of example only, any number of paper sheets may be used by the present message reception unit (300), the paper sheets being any color; any configuration such as ruled, un-ruled, or graph; have any number of printed informational designs and/or information such as logos, trademarks, business information, etc; be any shape such as quadratic, round, triangular, etc; or have any number of edge treatments. Additionally, the paper sheets may be made of any number of materials and using different processes. Consequently, the paper sheets may also have a number of textures and weights.

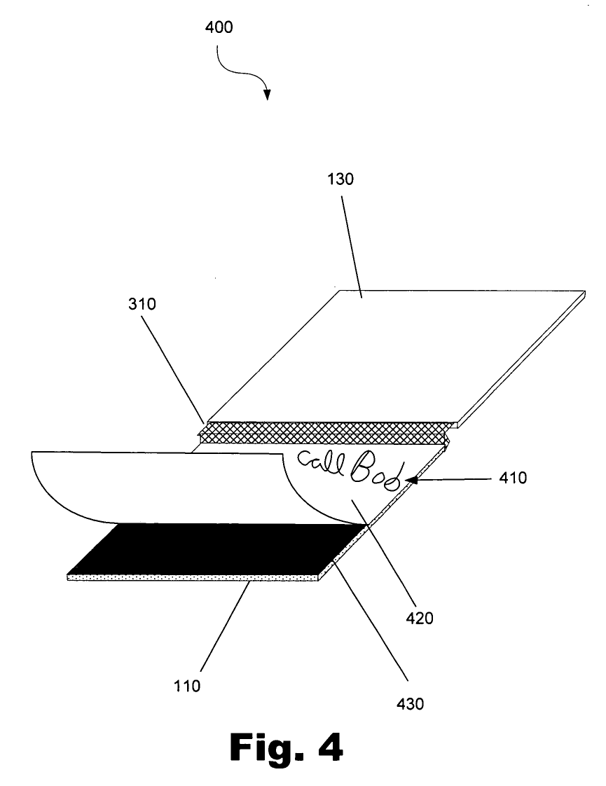

According to another exemplary embodiment, the message receptive medium (120) illustrated in FIG. 3 is replaced by an erasable message receptive unit (400). According to this exemplary embodiment, illustrated in FIG. 4, an erasable message receptive unit (400) may include any surface configured to repeatedly receive and erase multiple messages on a single surface. According to the exemplary embodiment illustrated in FIG. 4, the erasable message receptive unit (400) includes a pad cover (130) and a backing (110), similar to the message reception unit (300; FIG. 3), joined by a binder (310). However, the message receptive medium (120; FIG. 3) is replaced by a semi-transparent film (420) disposed above a semi-adhesive contrast surface (430) such as a colored wax.

According to this exemplary embodiment, pressure exerted upon the semi-transparent film (420) by a stylus (not shown) or another pressure focusing device causes an adhesion between the semi-transparent film (420) and the semi-adhesive contrast (430). As adhesion is introduced at the points of pressure, the semi-adhesive contrast (430) is viewable through the semi-transparent film (420) to a user. Consecutive points of pressure may then be selectively applied to form an image, to record a message (410), or record other information to be viewed by a user. According to this exemplary embodiment, when a user desires to erase the formed image or message (410), the semi-transparent film is pulled away from the semi adhesive contrast (430) such that the points of pressure are released and the image or message (410) disappears.

While the exemplary embodiment illustrated in FIG. 4 is explained in the context of semi-transparent film (420) disposed adjacent to a semi-adhesive contrast (430), any number of erasable surfaces may be incorporated to replace the message receptive medium (120; FIG. 3) of the message reception unit (300; FIG. 3). Erasable message receptive units may include, but are in no way limited to, dry-erase boards, chalk boards, and the like. Additionally, according to one exemplary embodiment, the message receptive medium (120; FIG. 3) of the message reception unit (300; FIG. 3) may be replaced by an electronic message or note device, including, but in no way limited to, a personal digital assistant (PDA), a palm computer, a cellular telephone, a substrate having electronic-ink or magnetic-ink capabilities, and/or a pager.

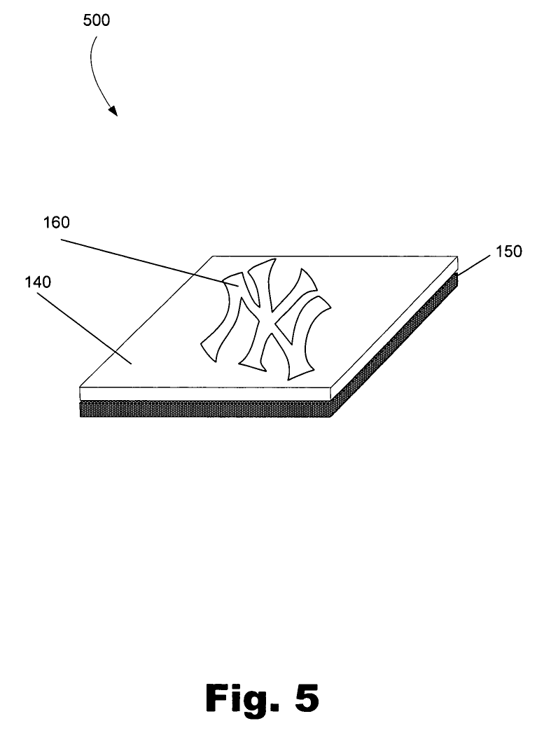

While the message reception unit (300; FIG. 3) adds functionality and utility to the promotional unit (100; FIG. 1), the extended life unit (500) illustrated in FIG. 5 is configured to provide promotional information to a potential consumer long after the useful life of the message reception unit (100; FIG. 1). As illustrated in FIG. 5, an extended life unit (500) of the present promotional unit (100; FIG. 1), may include a logo receptive medium (140) having a logo (160) disposed thereon securely coupled to a magnetic surface (150), according to one exemplary embodiment. According to the present system and method, the extended life unit (500) is configured to outlast the useful life of the other components of the promotional unit (100; FIG. 1) while maintaining the promotional integrity of the unit. According to the exemplary embodiment illustrated in FIG. 5, the extended life unit (500) is removably coupled to the message reception unit (300; FIG. 3) such that the extended life unit (500) may be removed from the promotional unit (100; FIG. 1) after the useful life of portions of the promotional unit (100; FIG. 1) have expired. According to the exemplary embodiment illustrated in FIG. 5, the magnetic surface (150) disposed on the back of the logo receptive medium (140) is configured to couple the extended life unit (500) to a file cabinet, a fridge, or any other metallic surface that is often present before a consumer. According to this exemplary embodiment, when the message reception unit (300; FIG. 3) has used up its useful life, the extended life unit (500) continues to fulfill is promotional purpose by “sticking on” or otherwise adhering to a surface that is often present before a consumer.

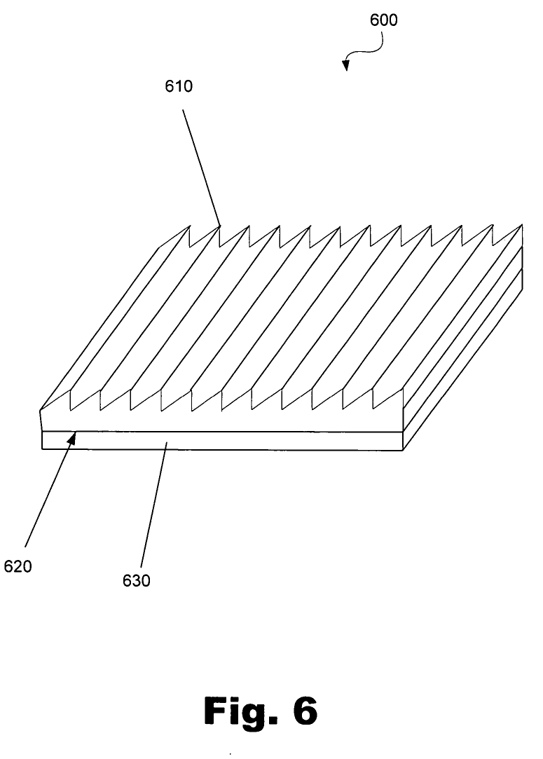

According to one exemplary embodiment illustrated in FIG. 5, the logo receptive medium (140) and the logo (160) or other source identifier coupled to the magnetic surface (150) includes, but is in no way limited to, a lenticular display device. As illustrated in FIG. 6, the lenticular display device (600) may include, according to one exemplary embodiment, a substantially transparent substrate having a lenticular surface (610) disposed on a side opposite to a planar surface (620). According to the above-mentioned exemplary embodiment, the substantially transparent substrate is disposed adjacent to a customizable lenticular arranged image (630) bearing a desired logo (160) or source identifier such that the lenticular arranged image (630) is adjacent to the planar surface (620) of the lenticular device (600). The lenticular arranged image (630) is then viewed from the perspective of the lenticular surface (610). Further explanations of the workings of a lenticular device are given below.

Lenticular lenses are thin, transparent lenses that are substantially planar on one side and include a lenticular surface (610) having a plurality of parallel, linear, side-by-side lenticules or elongate, convex lenses on a second side. The combination of a lens and a lenticular arranged image is referred to herein as a lenticular device (600).

Typically, an image is printed onto or placed adjacent to the flat side of the lenticular lens to create a visual effect or illusion. A number of visual effects or illusions may be produced with a lenticular device including, but in no way limited to, zoom-in, zoom-out, stereoscoping, two-dimensional sequencing, three-dimensional sequencing, and/or movements such as “flips”, full motion video, and/or “morphing” of the image when viewed through the lenticular surface (610). A “flip” represents an abrupt change from one viewed image to another different image. “3-D” effects produce an illusion of depth for an object being viewed. Full motion video produces a sense of movement of an object being viewed as the viewing angle changes with respect to the lenticular surface (610). “Morphing” produces an illusion of a metamorphosis (transition) from one image to another as the viewing angle changes. Zooming presents a size change in an object being viewed, the object appearing to move either closer to, or away from, the viewer.

In order to produce the above-mentioned effects on an image when viewed through a lenticular surface (610), precise registration is desirable between the lenticular arranged image (630) and the lenticular surface (610). According to one exemplary embodiment, the lenticular arranged image (630) includes a number of different segments of an image printed by an in-line printing system on sequential transparent layers of material, with one segment of the image, such as the background for example, printed on a paper stock material which forms the bottom layer of the finished product. The final image produces the appearance of depth since the various segments of the image are actually at a distance from each other.

According to one exemplary embodiment, the lenticular arranged image (630) disposed beneath the lenticular surface (610) is a line formed image, and is aligned or registered under the lenticular surface. As light passes through the lenticular surface (610) and passes the focal length of the lenticular device (600), it is focused onto the lenticular arranged image (630). The spatial frequency of the lenticular arranged image (630) is matched to the foci of the lenses that form the lenticular surface (610). Each image is an independent line behind the lens, and each lens is divided into a plurality of segments. As light passes through the lenticular surface (610), the light is broken into a plurality of independent segments that reflect off of various line formed images, providing the above-mentioned effects. Additionally, by selectively placing a plurality of different line formed images on different lines, the lenticular arranged image can be made to change in the eyes of the viewer, depending on their viewing angle with respect to the lenticular surface (610).

The incorporation of a lenticular display device (600) onto the promotional unit (100; FIG. 1) provides a readily identifiable and modifiable surface that may be used for the promotion of a producer or manufacturer, while gaining utility from the previously mentioned message receptive medium (120; FIG. 1). Additionally, by coupling the lenticular display device (600) or other logo receptive medium (140; FIG. 5) to the magnetic surface (150; FIG. 5), the likelihood of a user retaining the extended life unit (500; FIG. 5) after the expiration of the message receptive medium (120; FIG. 1) is increased. In other words, a user is more likely to retain the extended life unit (500; FIG. 5), and consequently the vendor's logo (160; FIG. 5) or other source identifier if the extended life unit (500; FIG. 5) has its own functionality such as retaining messages on a refrigerator or a filing cabinet. Additionally, according to one exemplary embodiment, a logo or other promotional mark may be formed on the magnetic surface (150) using any number of known marking methods including, but in no way limited to, screen printing.

While the above-mentioned extended life unit (500; FIG. 5) was described in the context of a logo receptive medium (140; FIG. 5) bearing a logo (160; FIG. 5) in the form of a lenticular device (600), the logo receptive medium (140; FIG. 5) may include any number of ink or image receptive mediums capable of displaying a logo or source identifier (160; FIG. 5). The logo receptive medium may include, but is in no way limited to, any paper or plastic based substrate such as a paper business card, photographic paper, or the like.

Moreover, the logo receptive medium (140; FIG. 5) may also include a substrate hosting a readily modifiable ink. According to this exemplary embodiment, the logo receptive medium (140; FIG. 5) may include, but is in no way limited to, a substrate and any circuitry used to host and support a magnetic ink, an electronically modifiable ink, and/or one or more light emitting diodes (LED).

Alternatively, the logo receptive medium (140; FIG. 5) of the present promotional unit (100; FIG. 1) may be an engraved metal cover. According to this exemplary embodiment, the engraved metal cover may be manufactured out of any number of materials including, but in no way limited to, aluminum, steel, stainless steel, silver, gold, copper, tin, and the like.

Additionally, according to one exemplary embodiment, the logo receptive medium (140; FIG. 5) of the present promotional unit (100; FIG. 1) may be an embossed leather cover removably coupled to the message reception unit (300; FIG. 3). According to this exemplary embodiment, a desired logo (160; FIG. 5) may be formed on the leather cover which is then removably coupled to the message reception unit (300; FIG. 3).

Disposed onto the logo receptive medium (140; FIG. 5) is a logo (160; FIG. 5) or other source identifying illustration. According to the present system and method, the logo (160; FIG. 5) may include, but is in no way limited to, a trademark, a sports logo, a product picture, a hologram, a business title, a commonly used slogan, a calendar, a person's likeness, an animal's likeness, or any other source identifiable illustration or symbol having promotional value. Similarly, the logo (160; FIG. 5), or other source identifying illustration that may be disposed onto the logo, may take any number of forms and may be applied in any number of methods including, but in no way limited to, screen printing such as a four color process or a spot color process; engraving; inkjet printing; laser printing; hand painting; or any other image forming method.

As mentioned previously, the backing of the extended life unit (500; FIG. 5) is a magnetic surface (150; FIG. 5) according to one exemplary embodiment. By coupling the logo receptive medium (140; FIG. 5) to a magnetic surface, the useful life of the extended life unit (500) is enhanced. The magnetic surface may be coupled to the logo receptive medium by an number of coupling methods including, but in no way limited to, adhesives such as glue and two-part epoxies; mechanical fasteners such as pins and clips; and/or thermal processes such as melting. According to one exemplary embodiment, the magnetic surface includes, but is in no way limited to, materials containing the elements iron, nickel, cobalt, magnetite, alnico, samarium, and/or neodymium.

Alternatively, the backing of the logo receptive medium (140; FIG. 5) may be another adhesive material configured to secure the logo receptive medium to a surface upon expiration of the message reception unit (300; FIG. 3). Alternative adhesive materials that may be used on the backing of the logo receptive medium (140; FIG. 5) include, but are in no way limited to, glues, adhesive tapes, suction cups, static electrically adhesive polymers, and the like.

According to one exemplary embodiment, the present promotional unit (100; FIG. 1) is produced to be substantially the size of a business card. According to this exemplary embodiment, the length and width of the promotional unit (100; FIG. 1) will be approximately two (2) inches by three and a half (3.5) inches. Producing the present promotional unit (100; FIG. 1) to be substantially the size of a business card is advantageous for a number of reasons including, but in no way limited to, ease of stacking a plurality of promotional units, traditional business card printing formats may be used to produce the logo (160; FIG. 1), and the promotional unit (100; FIG. 1) will be readily carried in a standard wallet or bill fold.

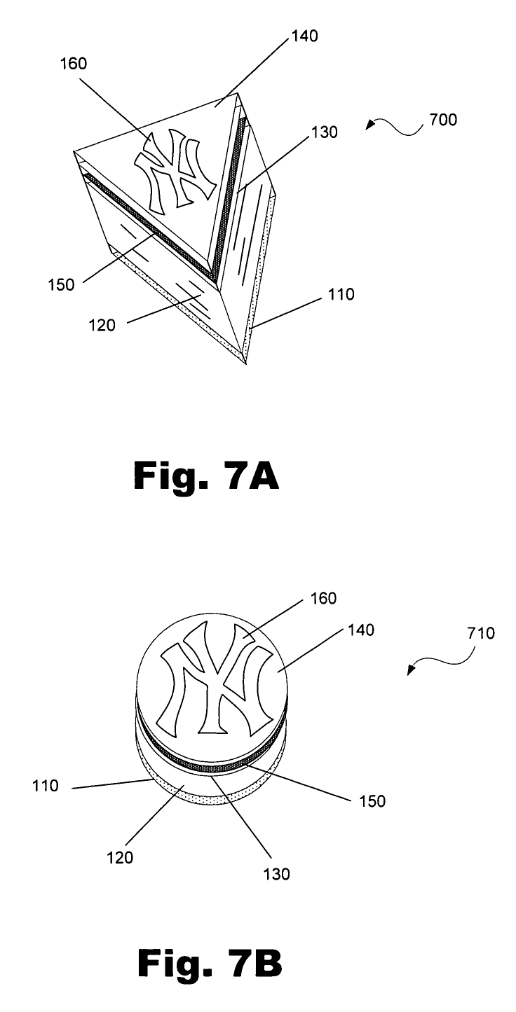

However, as illustrated in FIGS. 7A and 7B, the present promotional unit (100; FIG. 1) may alternatively assume any number of cross sectional shapes to further enhance its novelty and singularity. As illustrated in FIG. 7A, a triangular promotional unit (700) may be produced to have the same components as the original promotional unit (100; FIG. 1). Similarly, as illustrated in FIG. 7B, a circular promotional unit (710) may be produced. Consequently, the original promotional unit (100; FIG. 1) may be produced with any number of varying cross sectional shapes including, but in no way limited to, a square, a cube, a rectangle, a circle, a triangle, a diamond (rhomboid), a pentagon, a hexagon, an octagon, a polygon, a parallelogram, a trapezium, a cone, an oval (ellipse), or a silhouette. Additionally, the individual components of the present promotional unit (100; FIG. 1) may also include rounded edges, square corners, and/or any border design.

According to the present exemplary embodiment, the promotional unit (100; FIG. 1) increases the initial retention of the promotional unit due to the usefulness of the message reception medium while extending the promotional capabilities of the logo receptive medium.

### ALTERNATIVE EMBODIMENTS

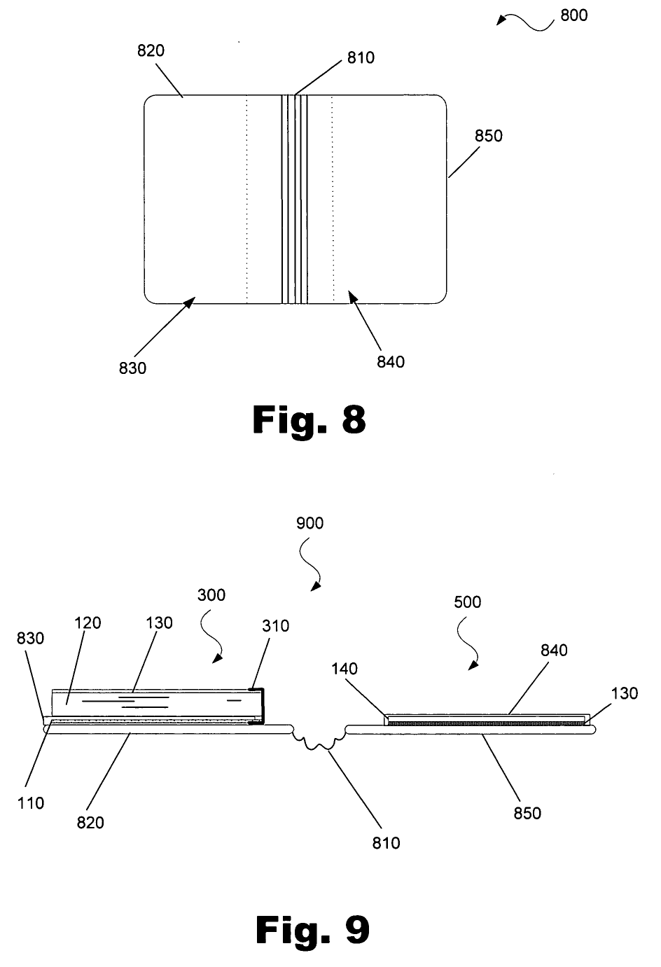

According to one alternative embodiment illustrated in FIGS. 8 and 9, the message reception unit (300; FIG. 3) and the extended life unit (500; FIG. 5) of the present promotional unit (100; FIG. 1) may be coupled by a folding promotional housing (800). As illustrated in FIG. 8, the folding promotional housing (800) may include a front cover (850) and a back cover (820) coupled by a flex binding (810). Additionally, according to the exemplary embodiment illustrated in FIG. 8, the front cover (850) may include one or more front pouches (840) and the back cover (820) may have one or more back pouches (830) formed therein.

According to the alternative embodiment illustrated in FIG. 8, the folding promotional housing (800) may be made out of any number of materials including, but in no way limited to, polymers, metals, composites, and/or appropriate combinations thereof. According to one exemplary embodiment, the folding promotional housing illustrated in FIG. 8 includes a structural plastic forming the front (850) and back (820) covers coupled by a flexible striated ribbon of plastic to form the flex binding (810). Additionally, a film may be heat sealed on a plurality of the cover's edges to form the front (840) and back pouch (830). According to the present alternative embodiment, the folding promotional housing may be formed with any number of pouches on any combination of cover sides. The cover may be completely sealed to permanently retain an extended life unit (500; FIG. 5) within the pouch, or it may be sealed on less than all sides to form a pouch. Additionally, according to one exemplary embodiment, the resulting pouches formed on the covers of the folding promotional housing (800) correspond in size to a desired extended life unit (500; FIG. 5) and a message reception unit (300; FIG. 3), and/or a business card as illustrated in FIG. 9.

As illustrated in FIG. 9, an assembled promotional unit (900) coupling a message reception unit (300) and an extended life promotional unit (500) are coupled through the front (840) and the back (830) pouches formed on the front (850) and back (820) covers respectively. According to the exemplary embodiment illustrated in FIG. 9, the extended life promotional unit (500) including a logo receptive medium (140) and a magnetic surface (130), according to one exemplary embodiment, are securely disposed within the front pouch (840). According to the exemplary embodiment, a front pouch (840), and consequently, the extended life unit (500) may be disposed on either or both sides of the front cover (850). Similarly, the message reception unit (300), including the pad cover (130), the message receptive medium (120) and the backing (110) are bound by a binder (310) and securely coupled to the back pouch (830) by inserting a portion of the backing (110) into the back pouch. Accordingly, the message reception unit (300) may be securely coupled to the assembled promotional unit (900) while maintaining access to the message receptive medium (120). Alternatively, the pad cover (300) of the message reception unit (300) may be removed by allowing the front cover (850) to provide the covering and protective functions previously performed by the pad cover (130).

Additionally, the assembled promotional unit (900) may be configured to include a pouch for any number of devices including, but in no way limited to, recording device, visual or hand written devices such as personal digital assistants (PDAs), credit card pouches, and/or pockets configured to house a memory stick or a flash memory. As mentioned previously, the pouch may be formed in either the backing (110) or the pad cover (130) according to various exemplary embodiments.

Further, as illustrated in the additional drawings attached hereto, the various components of the message reception unit (300) may be coupled via an independent boot configured to provide an interference fit having two c-channels; one for promotional item and another for the message receptive medium. These exemplary configurations illustrated in the attached drawings allow the groupings to be customizable. Any number of semi-rigid materials that allow some deflection while returning to a compressive state may be used including, but in no way limited to a neoprene material. Further, the boot may be imprinted with any number of promotional drawings, symbols, words, etc.

In conclusion, the present system for producing a single promotional unit configured to provide a utilitarian value to potential customers while simultaneously facilitating the retention and identification of a source allows for increased promotion of a desired product, business, or person. More specifically, the present promotional unit includes a useful message reception unit configured to give immediate usefulness to the promotional unit, thereby reducing the immediate discarding of the promotional unit. Additionally, the present promotional unit includes an extended life unit configured to provide promotional value to the promotional unit long after the message reception unit has expired.

The preceding description has been presented only to illustrate and describe the present method and system. It is not intended to be exhaustive or to limit the present method and system to any precise form disclosed. Many modifications and variations are possible in light of the above teaching.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

What is claimed is:

1. A promotional system comprising:
a logo receiving medium; and
a message reception component removably coupled to said logo receiving medium;
wherein said message reception component includes a message reception medium having a limited life, a backing, and a cover;
said message reception component being coupled between said backing and said cover.

2. The promotional system of claim 1, wherein said logo receiving medium comprises:
a transparent substrate having a lenticular surface on a first side and a flat surface on a second side; and
a line formed image printed on said flat surface of said transparent substrate, said line formed image including a first portion and a second portion;
wherein said first and second portions of said line formed image are in register to create a visual effect when viewed through said lenticular surface.

3. The promotional system of claim 2, wherein said visual effect comprises one of a zoom-in effect, a zoom-out effect, a stereoscoping effect, a two-dimensional sequencing effect, a three-dimensional sequencing effect, a flip, a full motion video, or a morphing effect.

4. The promotional system of claim 2, further comprising a magnetic material coupled to said logo receiving medium.

5. The promotional system of claim 2, further comprising one of an adhesive, suction cups, or a calendar coupled to said logo receiving medium.

6. The promotional system of claim 1, wherein said logo receiving medium further comprises one of a screen printed logo, a business card, a light, a metal cover, an embossed leather surface, or a holographic surface.

7. The promotional system of claim 1, wherein said message reception medium comprises a plurality of paper coupled together between said backing and said cover.

8. The promotional system of claim 1, wherein said message reception medium further comprises one of a personal digital assistant (PDA), a cell phone, an electronic ink surface, a magnetic ink surface, a pager, a semi-transparent film disposed adjacent to a semi-adhesive contrast surface, a dry erase surface, or a chalk board.

9. The promotional system of claim 1, further comprising:
a body configured to surround at least three surfaces of said message reception component, said body being coupled to said message reception component;
a first pocket formed on an outer surface of said body; and
a second pocked formed on an inner surface of said body.

10. The promotional system of claim 9, wherein said logo receiving medium is disposed in said first pocket.

11. The promotional system of claim 9, wherein said body is coupled to said message reception component by disposing said backing into said second pocket formed in said body.

12. The promotional system of claim 1, wherein said promotional system comprises a footprint substantially similar to a standard business card.

13. The promotional system of claim 1, wherein said logo comprises one of a trademark, a sports logo, a hologram, a product image, a business title, a commonly used slogan, a calendar, a person's likeness, or an animal's likeness.

14. A promotional system comprising:
a logo receiving medium coupled to a magnetic substrate, said logo receiving medium including a transparent substrate having a lenticular surface on a first side, a flat surface on a second side, and a line formed image printed on said flat surface of said transparent substrate, said line formed image including a first portion and a second portion, wherein said first and second portions of said line formed image are in register to create a visual effect when viewed through said lenticular surface; and
a message reception component removably coupled to said logo receiving medium, wherein said message reception component includes a message reception medium having a limited life, a backing, and a cover, said message reception component being coupled between said backing and said cover;
said promotional system having a cross-sectional surface substantially the size of a traditional business card.

15. The promotional system of claim 14, wherein said visual effect comprises one of a zoom-in effect, a zoom-out effect, a stereoscoping effect, a two-dimensional sequencing effect, a three-dimensional sequencing effect, a flip, a full motion video, or a morphing effect.

16. The promotional system of claim 14, wherein said logo receiving medium further comprises one of a screen printed logo, a business card, a light, a metal cover, an embossed leather surface, or a holographic surface.

17. The promotional system of claim 14, wherein said message reception medium comprises a plurality of paper coupled together between said backing and said cover.

18. The promotional system of claim 14, wherein said message reception medium further comprises one of a personal digital assistant (PDA), a cell phone, an electronic ink surface, a magnetic ink surface, a pager, a semi-transparent film disposed adjacent to a semi-adhesive contrast surface, a dry erase surface, or a chalk board.

19. The promotional system of claim 14, wherein said logo comprises one of a trademark, a sports logo, a hologram, a product image, a business title, a commonly used slogan, a calendar, a person's likeness, or an animal's likeness.

20. A method for manufacturing a promotional component comprising:
forming a message reception component, said message reception component including a message reception medium having a limited life, a backing, and a cover, said message reception component being coupled between said backing and said cover;
forming a logo receiving medium coupled to a magnetic substrate, said logo receiving medium including a transparent substrate having a lenticular surface on a first side, a flat surface on a second side, and a line formed image printed on said flat surface of said transparent substrate, said line formed image including a first portion and a second portion, wherein said first and second portions of said line formed image are in register to create a visual effect when viewed through said lenticular surface; and
removably coupling said message reception component to said logo receiving medium.

21. The method of claim 20, wherein said removably coupling said message reception component to said logo receiving medium further comprises:
dispensing an adhesive onto said message reception component or said logo receiving medium; and
joining said message reception component, said logo receiving medium, and said adhesive.

22. The method of claim 20, further comprising forming said promotional component promotional to have a footprint substantially similar to a standard business card.

23. The method of claim 20, further comprising forming a logo on said logo receiving medium.

24. The method of claim 23, wherein said forming a logo on said logo receiving medium comprises performing one of a screen printing process, an etching process, an embossing process, a holographic image forming process, or a lenticular forming process.

25. The method of claim 23, wherein said logo comprises one of a trademark, a sports logo, a hologram, a product image, a business title, a commonly used slogan, a calendar, a person's likeness, or an animal's likeness.
